(19) United States
(12) Patent Application Publication
(10) Pub. No.: US 2012/0212672 A1
(43) Pub. Date: Aug. 23, 2012

(54) METHOD AND APPARATUS FOR CONTROLLING SETTINGS OF A DEVICE FOR PLAYBACK OF A CONTENT ITEM

(75) Inventor: Frank Kamiel Irena Mels, Sint-Amandsberg (BE)

(73) Assignee: KONINKLIJKE PHILIPS ELECTRONICS N.V., EINDHOVEN (NL)

(21) Appl. No.: 13/497,839

(22) PCT Filed: Oct. 25, 2010
(86) PCT No.: PCT/IB10/54819

§ 371 Date: Mar. 23, 2012

(30) Foreign Application Priority Data
Nov. 6, 2009 (EP) 09175183.4

(51) Int. Cl. H04N 3/27

(52) U.S. Cl. 348/554; 348/E03.049

(57) ABSTRACT

A method for controlling settings of a rendering device (100) for playback of a content item, said rendering device (100) being connectable to at least one source device (110), said at least one source device (110) providing at least one content item, the method comprising the steps of: generating a plurality of entries (220_{—}1 to 220_{—}9) for one or more of said at least one source device (110), each of the plurality of entries (220_{—}1 to 220_{—}9) corresponding to a different profile, each profile comprising settings for playback of a content item received from the corresponding source device (110); enabling a user to select one of said entries; and controlling settings of said rendering device (100) for playback of the received content item according to the profile corresponding to said selected entry.

### FIELD OF THE INVENTION

The present invention relates to method and apparatus for controlling settings of a device for playback of a content item.

### BACKGROUND OF THE INVENTION

Home entertainment systems now enable an ever increasing number of devices to be connected and rendered via a rendering device such as a television. For example, the television may be connected to a plurality of source sevices such as a DVD and/or Blu-Ray player for playback of movies or music, a hard disk recorder for playback of scheduled programming or enabling pausing of live television programs, games consoles, computer systems etc.

Each of these devices is connected to the television via an input terminal and content items are transmitted to the television for rendering according to a general television setting profile or according to the television setting profile for that input terminal. A user may be able to select a profile by associating a source device type with the input terminal. When the source device is activated, the television will render it using the associated profile which optimizes video and audio settings for the required use. Each profile may comprise multiple settings.

Some of these source devices, however, may support multiple capabilities (activities), i.e. a game console that plays games and plays DVDs. The profile settings of the television for playing games, PC applications and playing movies are very different. Invariably, use of such systems, for example Home Theatre PC (HTPC) systems which are both used for viewing movies and playing games require different settings for example, in watching a movie, a high picture quality is preferable (this means increased video processing and as a result an increased video latency of up to 200 ms). This would not be appropriate for playing a game which requires high speed action that would be compromised by this video latency. Further using this gaming profile having decreased video processing latency for watching movies gives rise to a poorer video quality. Further audio settings can be varied for appropriateness for a movie mode or a music mode or any other type of mode. In music mode it may be desirable to add background screens or animations.

In conventional systems, this requires the user to enter the set up mode for the television and reenter profile settings to change between different activities that are carried out on the same source device. This is extremely cumbersome and time consuming.

### SUMMARY OF THE INVENTION

Therefore, it would be desirable to provide appropriate settings for playback of different types of content items.

This is achieved according to a first aspect of the present invention by a method for

controlling settings of a rendering device for playback of a content item, said rendering device being connectable to at least one source device, said at least one source device providing at least one content item, the method comprising the steps of: generating a plurality of entries for one or more of said at least one source device, each of the plurality of entries corresponding to a different profile, each profile comprising settings for playback of a content item received from the corresponding source device; enabling a user to select one of said entries; and controlling settings of said rendering device for playback of the received content item according to the profile corresponding to said selected entry.

This is also achieved according to yet another aspect of the present invention by an apparatus for playback of a content item, the apparatus comprising: at least one input connected to at least one source device, said at least one source device providing at least one content item, one or more of said at least one input having a plurality of entries, each of said plurality of entries corresponding to a different profile, each profile comprising settings for playback of a content item received from the corresponding source device; a user interface for enabling a user to selecting one of said plurality of entries; and a controller for controlling settings of said apparatus for playback of said received content item according to the profile corresponding to said entry.

This is achieved, therefore, by enabling multiple profiles on the same input by means of multiple assignment of the same input in the source selection menu so that the rendering device is informed of which profile to use and hence which settings.

The user may create multiple versions of profiles for the same input. This input could than be listed more than once in the channel list/source selection list but with different profiles. The user can then easily make a source change to connect to a multifunctional source device and have the correct settings to render a particular content item being provided by the source device. This may be achieved by visualizing a group of activities for a source device. This may be in the form of a list/pictograms of possible activities per source device, each of these activities may have a default profile with best average settings which can be optimized by the user but which are unique to this source device combined with that activity.

For example, if the user wants to watch a Blu-Ray movie then he will need to start up the Blu-Ray player and select the correct source device activity in the user interface of the rendering device.

### BRIEF DESCRIPTION OF DRAWINGS

For a more complete understanding of the present invention, reference is now made to the following description taken in conjunction with the accompanying drawings in which:

FIG. 1 is a simplified schematic of apparatus according to an embodiment of the present invention; and

FIG. 2 is a typical display screen of an embodiment of the present invention.

### DETAILED DESCRIPTION OF EMBODIMENTS OF THE INVENTION

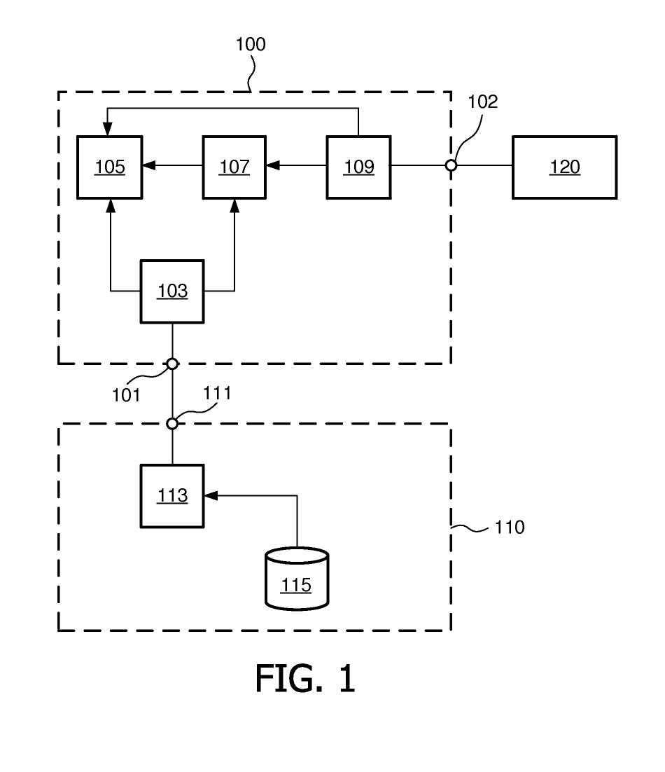

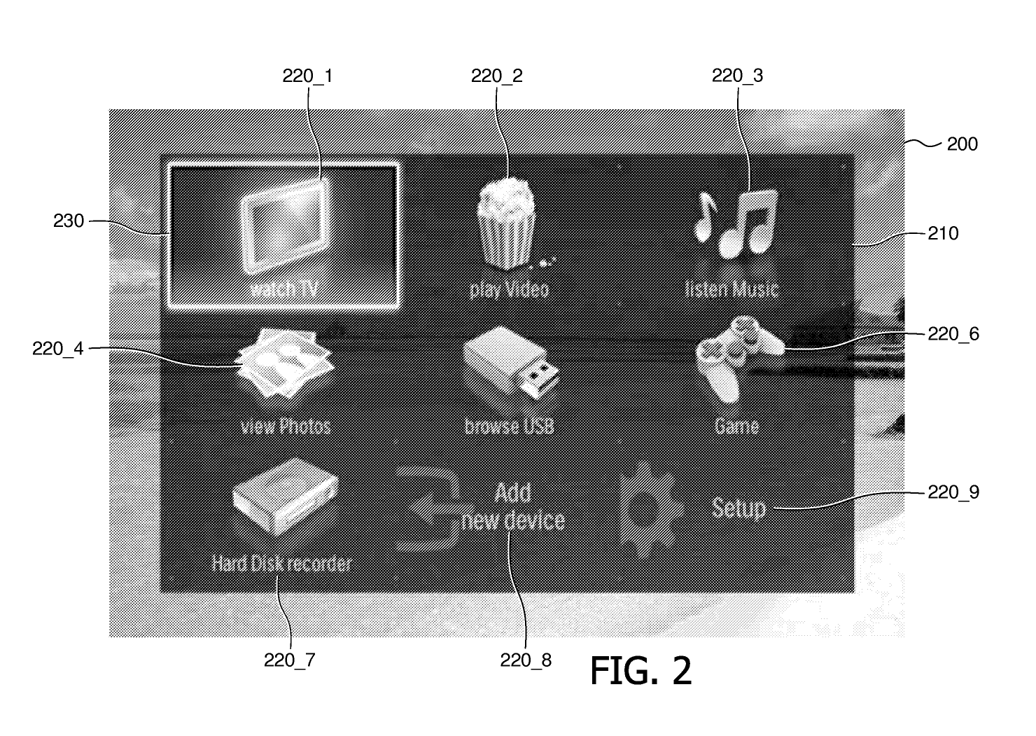

Embodiments of the present invention will now be described with reference to FIGS. 1 and 2.

The system comprises a rendering device 100 connected to at least one source device 110 via a first terminal 101 of the rendering device 100 and an output terminal 111 of the source device 110. The communication link between the devices may be a HDMI-CEC spec communication. The first terminal 101 of the rendering device 100 is connected to a receiver 103. The outputs of the receiver 103 are connected to a display or loud speaker 105, combination or the like and a controller 107. The controller 107 and the display/loud speaker 105 are connected to a user interface 109. The user interface 109 is connected to a second terminal 102. The second terminal 102 is connected to a remote control device, keyboard, key pad, touch sensitive screen or the like for receiving input commands from a user.

The source device 110 comprises a storage device 115 connected to a transmitter 113. The output of the transmitter is connected to the output terminal 111 of the source device 110.

Operation of the system will now be described in more detail with reference to FIGS. 1 and 2.

The user, via the input device 120 creates multiple profiles for a source device 110 connected to the rendering device 100. These profiles are in the form of activities supported for that particular source device. The user can edit the settings for that profile to meet his own requirements or select default settings such as watch Blu-Ray, play game, listen to music.

The user may create a plurality of entries for each source device. Each entry corresponds to a different profile and each profile comprises settings for playback of a content item. The user interface 109 may provide lists or an array 210 of pictograms 220_1 to 220_9 on the screen 200 of the display 105 as shown in FIG. 2.

The pictograms 220_1 to 220_4 and 220_6 are in the form of the activities set up by the user and have a profile associated therewith. The profile may include settings for video and possibly also for audio to have the correct ambiance for the given activity. The user interface 109 may further provide an option 220_8 to add a new device or to allow set up of the profiles 220_9. Each activity or profile has at least one source device associated therewith. As a result any one source device may have more than one profile associated therewith.

Any one of the pictograms 220_1 to 220_9 is selected by moving the highlight 230 across the array 210 in a conventional manner. As shown in FIG. 2, the user interface 109 has grouped the profiles by activities. In alternative embodiment, the profiles may be grouped by the source device in which case each pictogram would depict the name of the source device.

In using the system to playback a content item, the user may select “play video”, pictogram 220_2 for example. A content item is loaded into the storage device 115 of a source device 110. This may in the form of a broadcast program, a Blu-Ray disc, DVD, an item retrieved from a hard disk storage medium. The content item is then transferred to the rendering device via the transmitter 113 and the communication link between the output terminal 111 of the source device 110 and the first terminal 101 of the rendering device 100. The content item is received by the receiver 103. The controller 107 takes the profile for the activity “play video” selected by the user and uses the settings for that profile to render the content item irrespective of the source device used to communicate the content item.

When the user selects pictogram 220_7, the user does not indicate to the rendering device 100 which activity the user is going to use the Hard Disk recorder, corresponding to pictogram 220_7, for. In order for the rendering device 100 to still use the best settings, the Hard Disk recorder transmits an indication of the mode of operation, e.g. play back movie or play back music, to the rendering device. When the Hard Disk recorder is used to play back music, the rendering device 100 may switch off its back light, for example.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for controlling settings of a rendering device (100) for playback of a content item, said rendering device (100) being connectable to at least one source device (110), said at least one source device (110) providing at least one content item, the method comprising the steps of:
generating a plurality of entries (220_1 to 220_9) for one or more of said at least one source device (110), each of the plurality of entries (220_1 to 220_9) corresponding to a different profile, each profile comprising settings for playback of a content item received from the corresponding source device (110);
enabling a user to select one of said entries; and
controlling settings of said rendering device (100) for playback of the received content item according to the profile corresponding to said selected entry.

2. A method according to claim 1, further comprising the step of:
enabling a user to select a plurality of entries (220_1 to 220_9) from a plurality of candidate entries to be associated with said one or more of said at least one source device (110).

3. A method according to claim 1, wherein at least one of said plurality of entries represents at least one of playing back a movie, playing back music and playing a game.

4. A method according to claim 1, wherein at least one of said profiles comprises at least one of video latency settings and audio latency settings.

5. A computer program product comprising a plurality of program code portions for carrying out the method according to claim 1.

6. Apparatus (100) for playback of a content item, the apparatus (100) comprising:
at least one input (110) connected to at least one source device (110), said at least one source device (110) providing at least one content item, one or more of said at least one input having a plurality of entries, each of said plurality of entries corresponding to a different profile, each profile comprising settings for playback of a content item received from the corresponding source device (110);
a user interface (109) for enabling a user to selecting one of said plurality of entries; and
a controller (107) for controlling settings of said apparatus (100) for playback of said received content item according to the profile corresponding to said entry.

7. Apparatus (100) according to claim 6, wherein the user interface (109) further enables a user to select a plurality of entries from a plurality of candidate entries to be associated with said one or more of said at least one input.

8. Apparatus (100) according to claim 6, wherein at least one of said plurality of entries represents at least one of playing back a movie, playing back music and playing a game.

9. An apparatus (100) according to claim 6, wherein at least one of said profiles comprises at least one of video latency settings and audio latency settings.
